(19) United States
(12) Patent Application Publication
(10) Pub. No.: US 2026/0214575 A1
(43) Pub. Date: Jul. 23, 2026

(54) CHANNEL STATE INFORMATION ENHANCEMENTS FOR NETWORK ENERGY SAVINGS

(71) Applicant: Lenovo (Singapore) Pte. Limited, Singapore (SG)

(72) Inventors: Ahmed Hindy, Aurora, IL (US); Vijay Nangia, Woodridge, IL (US)

(73) Assignee: Lenovo (Singapore) Pte. Limited, Singapore (SG)

(21) Appl. No.: 19/134,595

(22) PCT Filed: Feb. 5, 2024
(86) PCT No.: PCT/IB2024/051042

§ 371 Date: May 30, 2025

Related U.S. Application Data
(60) Provisional application No. 63/483,805, filed on Feb. 8, 2023.

(51) Int. Cl. H04W 52/02; H04W 24/10; H04W 72/1268; H04W 72/232

(52) U.S. Cl. CPC H04W 52/0229; H04W 24/10; H04W 72/1268; H04W 72/232

(57) ABSTRACT

Various aspects of the present disclosure relate to an apparatus for CSI enhancements for NES. The apparatus, such as a user equipment (UE) receives a first signaling as an indication of a network energy saving (NES) mode, the NES mode activated and associated with a channel state information (CSI) reporting setting that includes a configuration for at least one of a reduced CSI feedback or a reduced number of channel state information reference signal (CSI-RS) ports per non-zero power (NZP) CSI-RS resource. The apparatus transmits a second signaling as a CSI report based at least in part on the CSI reporting setting associated with the NES mode.

### RELATED APPLICATION

This application claims priority to U.S. Provisional Application Ser. No. 63/483,805 filed Feb. 8, 2023 entitled “Channel State Information Enhancements for Network Energy Savings,” the disclosure of which is incorporated by reference herein in its entirety.

### TECHNICAL FIELD

The present disclosure relates to wireless communications, and more specifically to network energy savings (NES).

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communications system, such as time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Channel state information (CSI) feedback is reported by a UE back to the network (e.g., to a network entity, gNB), and the CSI feedback can take multiple forms based on the CSI feedback report size, time, and frequency granularity. A high-resolution CSI feedback report specifies that a frequency granularity of the CSI feedback can be indirectly parametrized, and the CSI feedback is considered for scenarios where UE speed is relatively high. However, an issue with these typical implementations is the significant CSI-reference signal (RS) overhead, as well as CSI-related computation complexity at both the network side and the UE side in a wireless communications system.

### SUMMARY

The present disclosure relates to methods, apparatuses, and systems that support CSI enhancements for NES. By utilizing the described techniques, CSI-RS transmission overhead and computational complexity at the network side is reduced, which conserves power at the network (e.g., by a network entity or network entities at network nodes in a wireless communications system). For periodic or semi-persistent CSI-RS transmission, all NZP CSI-RS ports of a given NZP CSI-RS resource are turned on in a first transmission occasion of the periodic or semi-persistent CSI-RS transmission. As described in this disclosure, only a subset of the NZP CSI-RS ports of the NZP CSI-RS resource are turned on in transmission occasions that are subsequent to the first transmission occasion of the periodic or semi-persistent CSI-RS transmission, where the subset of the CSI-RS ports is selected based on UE assistance in a NES mode.

Further, for downlink multi-TRP transmission, a UE is associated with a CSI-RS resource set for channel measurement configured with two resource groups and one or more resource pairs as part of a periodic or semi-persistent CSI resource configuration. In aspects of the disclosure, the UE is configured with periodic or semi-persistent CSI reporting, and only one pair of the one or more resource pairs is selected by the UE corresponding to a first CSI-RS transmission occasion, and only the selected resource pair is transmitted in subsequent CSI-RS transmission occasions. Additionally, the UE can be configured to measure the channel quality indicator (CQI) and select a subset of layers corresponding to a prior precoder matrix indicator (PMI) that is reported back by the UE so as to reduce the computation complexity of the precoding. Further aspects of the disclosure include updating CSI-RS transmission periodicity in time as well as the CSI-RS transmission frequency density to accommodate a required network energy constraint.

In some implementations of the method and apparatuses described herein, a UE receives a first signaling from a network entity corresponding to an indication of a NES mode, the NES mode activated and associated with a CSI reporting setting that includes a configuration for at least one of a reduced CSI feedback or a reduced number of channel state information reference signal (CSI-RS) ports per non-zero power (NZP) CSI-RS resource. The UE also transmits a second signaling as a CSI report based at least in part on the CSI reporting setting associated with the NES mode.

Some implementations of the method and apparatuses described herein may further include the UE receives the first signaling from the network entity indicating that the NES mode is activated for the network entity, or for one or more network entities in a wireless communications network that includes the network entity. The NES mode is activated via a parameter of one of the CSI reporting setting, a CSI resource setting, or an NZP CSI-RS resource setting. The NES mode is activated via downlink control information (DCI) corresponding to scheduling a physical uplink shared channel (PUSCH). An identifier of an aperiodic CSI reporting setting is indicated in a CSI reporting trigger list associated with a CSI request field of the DCI. The identifier identifies at least one of a periodic CSI reporting setting or a semi-persistent CSI reporting setting corresponding to an NZP CSI-RS resource setting.

Additionally, the CSI report includes a rank indicator (RI) value that is smaller than or equal to a threshold RI value associated with the NES mode. The UE is configured with a CSI reporting setting that includes a set of report quantities associated with the NES mode. The set of report quantities includes at least one of an indication of a sub-selection of at least one of a set of CSI-RS ports, a set of slots, or a set of frequency sub-bands; a CSI-RS resource indicator (CRI) corresponding to a CSI-RS resource identifier with a designated number of ports; or layer-one reference signal received power (L1-RSRP) corresponding to at least one CSI-RS resource with the designated number of ports. The UE is configured with a port selection codebook that includes a parameter that identifies a subset of the CSI-RS ports associated with the NES mode.

Additionally, an NZP CSI-RS resource configuration associated with the NES mode includes at least one parameter corresponding to a grouping of the NZP CSI-RS ports into two or more groups, each associated with an identifier of a respective group. The CSI report includes a CRI report quantity value as an index corresponding to a selected group of the NZP CSI-RS ports. The UE is configured with the NZP CSI-RS resource that includes at least one of a higher periodicity value associated with the NES mode than that of a periodicity value not associated with the NES mode; or a lower frequency density value associated with the NES mode than that of a frequency density value not associated with the NES mode. The CSI report includes a CQI value based at least in part on a PMI value reported in a prior CSI report. The NES mode is associated with a single layer corresponding to the CSI, an identification of the single layer is signaled in a form of a layer indicator (LI) value of the CSI report associated with the NES mode. The CSI report includes two CQI values including a first CQI value associated with the NES mode being activated, and a second CQI value associated with the NES mode being deactivated.

In some implementations of the method and apparatuses described herein, a network entity transmits a first signaling corresponding to an indication of a NES mode, the NES mode activated and associated with a CSI reporting setting that includes a configuration for at least one of a reduced CSI feedback or a reduced number of CSI-RS ports per NZP CSI-RS resource. The network entity also receives a second signaling as a CSI report based at least in part on the CSI reporting setting associated with the NES mode.

Some implementations of the method and apparatuses described herein may further include the NES mode is activated for the network entity, or for one or more network entities in a wireless communications network that includes the network entity. The NES mode is activated via a parameter of one of the CSI reporting setting, a CSI resource setting, or an NZP CSI-RS resource setting. The NES mode is activated via DCI corresponding to scheduling a PUSCH. An identifier of an aperiodic CSI reporting setting is indicated in a CSI reporting trigger list associated with a CSI request field of the DCI, the identifier identifying at least one of a periodic CSI reporting setting or a semi-persistent CSI reporting setting corresponding to an NZP CSI-RS resource setting.

Additionally, the CSI report includes a RI value that is smaller than or equal to a threshold RI value associated with the NES mode. A CSI reporting setting includes a set of report quantities associated with the NES mode, the set of report quantities including at least one of: an indication of a sub-selection of at least one of a set of CSI-RS ports, a set of slots, or a set of frequency sub-bands; a CRI corresponding to a CSI-RS resource identifier with a designated number of ports; or L1-RSRP corresponding to at least one CSI-RS resource with the designated number of ports. A port selection codebook includes a parameter that identifies a subset of the CSI-RS ports associated with the NES mode.

Additionally, an NZP CSI-RS resource configuration associated with the NES mode includes at least one parameter corresponding to a grouping of the NZP CSI-RS ports into two or more groups, each associated with an identifier of a respective group. The CSI report includes a CRI report quantity value as an index corresponding to a selected group of the NZP CSI-RS ports. The NZP CSI-RS resource includes at least one of a higher periodicity value associated with the NES mode than that of a periodicity value not associated with the NES mode; or a lower frequency density value associated with the NES mode than that of a frequency density value not associated with the NES mode. The CSI report includes a CQI value based at least in part on a PMI value reported in a prior CSI report. The NES mode is associated with a single layer corresponding to the CSI, an identification of the single layer is signaled in a form of a LI value of the CSI report associated with the NES mode. The CSI report includes two CQI values including a first CQI value associated with the NES mode being activated, and a second CQI value associated with the NES mode being deactivated.

### BRIEF DESCRIPTION OF THE DRAWINGS

FIG. 1 illustrates an example of a wireless communications system that supports CSI enhancements for NES in accordance with aspects of the present disclosure.

FIG. 2 illustrates an example of aperiodic trigger state defining a list of CSI report settings, as related to CSI enhancements for NES in accordance with aspects of the present disclosure.

FIG. 3 illustrates an example of aperiodic trigger state that indicates the resource set and quasi co-located (QCL) information, as related to CSI enhancements for NES in accordance with aspects of the present disclosure.

FIG. 4 illustrates an example of a RRC configuration for (a) a NZP-CSI-RS resource and (b) a CSI-IM resource, as related to CSI enhancements for NES in accordance with aspects of the present disclosure.

FIG. 5 illustrates an example of a partial CSI omission for PUSCH-based CSI as related to CSI enhancements for NES in accordance with aspects of the present disclosure.

FIGS. 6 and 7 illustrate an example of a block diagram of devices that supports CSI enhancements for NES in accordance with aspects of the present disclosure.

FIGS. 8-10 illustrate flowcharts of methods that support CSI enhancements for NES in accordance with aspects of the present disclosure.

### DETAILED DESCRIPTION

A wireless communications system includes CSI feedback reported by a UE back to the network (e.g., to a network entity, gNB), and the CSI feedback can take multiple forms based on the CSI feedback report size, time, and frequency granularity. A high-resolution CSI feedback report specifies that a frequency granularity of the CSI feedback can be indirectly parametrized, and the CSI feedback is considered for scenarios where UE speed is relatively high. However, an issue with these typical implementations is the significant CSI-RS overhead, as well as CSI-related computation complexity at both the network side and the UE side in a wireless communications system. Typically, reducing energy consumption at the UE is viewed as significantly more important compared with the network energy savings, however network energy savings is also a point of interest for network operators due to increases in energy prices, and moreover, due to local and federal requirements to reduce emissions, as well as the international efforts to promote green communications.

Accordingly, in aspects of CSI enhancements for NES, this disclosure describes proposed techniques that reduce CSI-RS transmission overhead and the computational complexity at the network side in a wireless communications system. As described, CSI-RS transmission overhead and computational complexity at the network side is reduced, which conserves power at the network (e.g., by a network entity or network entities at network nodes in a wireless communications system). For periodic or semi-persistent CSI-RS transmission, all NZP CSI-RS ports of a given NZP CSI-RS resource are turned on in a first transmission occasion of the periodic or semi-persistent CSI-RS transmission. In the described techniques, only a subset of the NZP CSI-RS ports of the NZP CSI-RS resource are turned on in transmission occasions that are subsequent to the first transmission occasion of the periodic or semi-persistent CSI-RS transmission, where the subset of the CSI-RS ports is selected based on UE assistance.

Further, for downlink multi-TRP transmission, a UE is associated with a CSI-RS resource set for channel measurement configured with two resource groups and one or more resource pairs as part of a periodic or semi-persistent CSI resource configuration. In aspects of the disclosure, the UE is configured with periodic or semi-persistent CSI reporting, and only one pair of the one or more resource pairs is selected by the UE corresponding to a first CSI-RS transmission occasion, and only the selected resource pair is transmitted in subsequent CSI-RS transmission occasions. Additionally, the UE can be configured to measure the CQI and select a subset of layers corresponding to a prior PMI that is reported back by the UE so as to reduce the computation complexity of the precoding. Further aspects of the disclosure include updating CSI-RS transmission periodicity in time as well as the CSI-RS transmission frequency density to accommodate a required network energy constraint.

Aspects of the present disclosure are described in the context of a wireless communications system. Aspects of the present disclosure are further illustrated and described with reference to device diagrams and flowcharts.

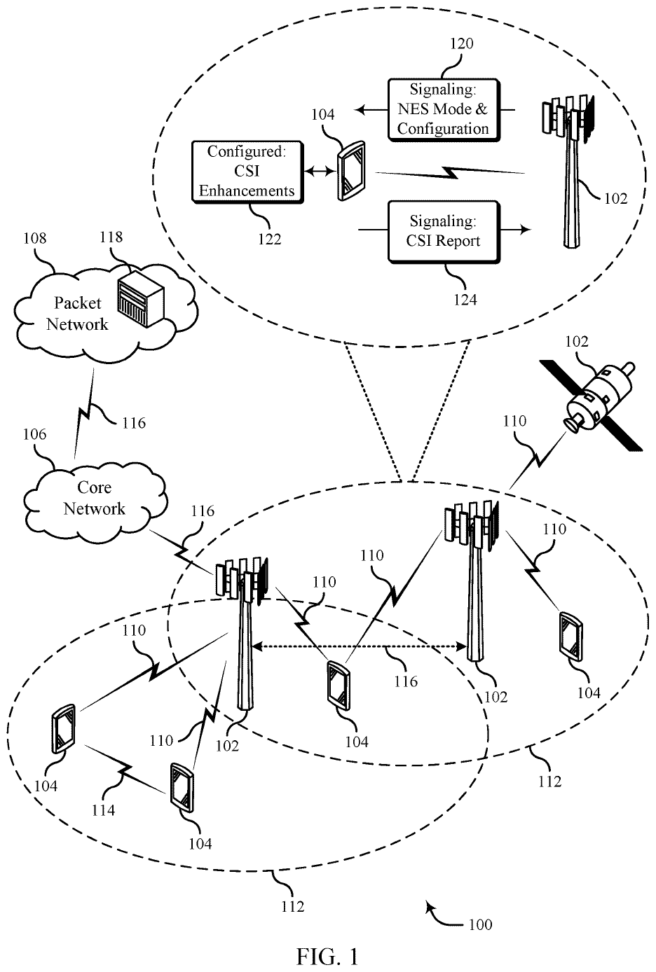

FIG. 1 illustrates an example of a wireless communications system 100 that supports CSI enhancements for NES in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N6, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N6, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communications system 100, such as time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHZ), FR4a or FR4-1 (52.6 GHz-71 GHz), and FR5 (114.25 GHZ-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the network entities 102 and the UEs 104 are operable to implement various aspects of CSI enhancements for NES, as described herein. For instance, a network entity 102 (e.g., a base station; gNB) communicates (e.g., transmits) a signaling 120 corresponding to an indication of a NES mode, where the NES mode is activated and associated with a CSI reporting setting that includes a configuration for a reduced CSI feedback or a reduced number of CSI-RS ports per NZP CSI-RS resource. The UE receives the indication of the NES mode (e.g., signaling 120) and is configured 122 with CSI enhancements according to the NES mode and CSI reporting configuration. The UE generates a CSI report and communicates (e.g., transmits) a signaling 124 as the CSI report to the network entity 102 based on the CSI reporting setting associated with the NES mode, and the network entity 102 receives the CSI report.

With reference to conventional solutions, a UE may be configured with multiple CSI reporting configurations whose associated network energy levels are variant, and the network can activate one of the multiple CSI reporting configurations based on the corresponding energy level requirement. However, a drawback is that a reduction of the spatial dimensions across the different CSI reporting configurations is not based on the channel conditions (i.e., the spatial domain reduction is not based on the actual CSI). Further, a conventional solution is to reduce the number of antenna elements per antenna port without reducing the number of CSI-RS ports. This approach may have no corresponding specification impact to support. A drawback is reducing the number of antenna elements per antenna port results in reducing the energy at the expense of changing the beam shape after antenna virtualization, resulting in reducing the direct signal and possibly increasing the interference on neighboring cells.

With reference to NR codebook types and timing for CSI reporting, new radio (5GNR) codebook types are taken into consideration, such as Type-II Codebook. With reference to NR (Rel. 15) Type-II codebook, a gNB can be equipped with a two-dimensional (2D) antenna array with N₁, N₂ antenna ports per polarization placed horizontally and vertically, and communication occurs over N₃ PMI sub-bands. A PMI sub-band consists of a set of resource blocks, with each resource block consisting of a set of subcarriers. In this case, 2N₁N₂ CSI-RS ports are utilized to enable downlink (DL) channel estimation with high resolution for NR (Rel. 15) Type-II codebook. In order to reduce the uplink (UL) feedback overhead, a discrete Fourier transform (DFT)-based CSI compression of the spatial domain is applied to L dimensions per polarization, where L<N₁N₂. In the sequel, the indices of the 2L dimensions are referred as the spatial domain (SD) basis indices. The magnitude and phase values of the linear combination coefficients for each sub-band are fed back to the gNB as part of the CSI report. The 2N₁N₂×N₃ codebook per layer/takes on the form:

$${W}_{l} = {W}_{1} {W}_{2 , l} ,$$

where W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N₁N₂×L matrix with columns drawn from a 2D oversampled DFT matrix, as follows:

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ]$$

$${v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T}$$

$$B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ]$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2}$$

where the superscript ^{T} denotes a matrix transposition operation. Note that O₁, O₂ oversampling factors are assumed for the 2D DFT matrix from which matrix B is drawn. Note that W₁ is common across all layers. W_{2,l} is a 2L× N₃ matrix, where the i^{th} column corresponds to the linear combination coefficients of the 2L beams in the i^{th} sub-band. Only the indices of the L selected columns of B are reported, along with the oversampling index taking on 0102 values. Note that W_{2,l} are independent for different layers.

With reference to NR (Rel. 15) Type-II Port Selection codebook, only K (where K≤2N₁N₂) beamformed CSI-RS ports are utilized in DL transmission, in order to reduce complexity. The K×N₃ codebook matrix per layer takes on the form:

$${W}_{l} = {W}_{1}^{PS} {W}_{2 , l} .$$

Here, W₂ follow the same structure as the conventional NR Type-II Codebook, and are layer specific

$${W}_{1}^{PS}$$

is a K×2L block-diagonal matrix with two identical diagonal blocks, i.e.,

$${W}_{1}^{PS} = [ \begin{matrix}E & 0 \\ 0 & E\end{matrix} ] ,$$

### and E is an

$$\frac{K}{2} \times L$$

matrix whose columns are standard unit vectors, as follows:

$$E = [ \begin{matrix}{e}_{mod ( {m}_{PS} {d}_{PS} , K / 2 )}^{( K / 2 )} & {e}_{mod ( {m}_{PS} {d}_{PS} + 1 , K / 2 )}^{( K / 2 )} & … & {e}_{mod ( {m}_{PS} {d}_{PS} + L - 1 , K / 2 )}^{( K / 2 )}\end{matrix} ] ,$$

$$where {e}_{i}^{( K )}$$

is a standard unit vector with a 1 at the i^{th} location. Here d_{PS} is an RRC parameter which takes on the values {1,2,3,4} under the condition d_{PS}≤min (K/2, L), whereas m_{PS} takes on the values

$$\{ 0 , ... , ⌈ \frac{K}{2 {d}_{PS}} ⌉ - 1 \}$$

and is reported as part of the UL CSI feedback overhead. W₁ is common across all layers.

For K=16, L=4 and d_{PS}=1, the 8 possible realizations of E corresponding to m_{PS}={0, 1, . . . , 7} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , \\ [ \text{} \begin{matrix}0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0\end{matrix} ] \text{} ,$$

$$[ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] , [ \begin{matrix}0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0\end{matrix} ] .$$

When d_{PS}=2, the 4 possible realizations of E corresponding to m_{PS}={0,1,2,3} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=3, the 3 possible realizations of E corresponding of m_{PS}={0,1,2} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=4, the 2 possible realizations of E corresponding of m_{PS}={0,1} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] .$$

To summarize, m_{PS} parametrizes the location of the first 1 in the first column of E, whereas d_{PS} represents the row shift corresponding to different values of m_{PS}.

With reference to NR (Rel. 15) Type-I codebook, the Type-I codebook is the baseline codebook for NR, with a variety of configurations. The most common utility of the Type-I codebook is a special case of NR Type-II codebook with L=1 for rank indicator (RI)=1, 2, wherein a phase coupling value is reported for each sub-band, i.e., W_{2,l} is 2×N₃, with the first row equal to [1, 1, . . . , 1] and the second row equal to [e^{j2π∅}^{_{N3-1}}, . . . , e^{j2π∅}^{_{N3-1}}]. Under specific configurations, φ₀=φ₁ . . . =φ, i.e., wideband reporting. For RI>2 different beams are used for each pair of layers. The NR Type-I codebook can be depicted as a low-resolution version of NR Type-II codebook with spatial beam selection per layer-pair and phase combining only.

With reference to NR (Rel. 16) Type-II codebook, a gNB can be equipped with a two-dimensional (2D) antenna array with N₁, N₂ antenna ports per polarization placed horizontally and vertically and communication occurs over N₃ PMI sub-bands. A PMI sub-band consists of a set of resource blocks, with each resource block consisting of a set of subcarriers. In this case, 2N₁N₂N₃ CSI-RS ports are utilized to enable DL channel estimation with high resolution for NR (Rel. 16) Type-II codebook. In order to reduce the UL feedback overhead, a DFT-based CSI compression of the spatial domain is applied to L dimensions per polarization, where L<N₁N₂. Similarly, additional compression in the frequency domain is applied, where each beam of the frequency-domain precoding vectors is transformed using an inverse DFT matrix to the delay domain, and the magnitude and phase values of a subset of the delay-domain coefficients are selected and fed back to the gNB as part of the CSI report. The 2N₁N₂×N₃ codebook per layer takes on the form:

$${W}_{l} = {W}_{1} {\tilde{W}}_{2 , l} {W}_{f , l}^{H} ,$$

where W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N₁N₂×L matrix with columns drawn from a 2D oversampled DFT matrix, as follows:

$${u}_{𝔪} = [ \begin{matrix}1 & {e}^{j \frac{2 π m}{{O}_{2} {N}_{2}}} & … & {e}^{j \frac{2 π m ( {N}_{2} - 1 )}{{O}_{{2}^{N} 2}}}\end{matrix} ] ,$$

$${v}_{l , 𝔪} = {[ \begin{matrix}{u}_{𝔪} & {e}^{j \frac{2 π l}{{O}_{1} {N}_{1}}} {u}_{𝔪} & … & {e}^{j \frac{2 π l ( {N}_{1} - 1 )}{{O}_{{1}^{N} 1}}} {u}_{𝔪}\end{matrix} ]}^{T} ,$$

$$B = [ \begin{matrix}{v}_{{l}_{0} , {m}_{0}} & {v}_{{l}_{1} , {m}_{1}} & … & {v}_{{l}_{L - 1} , {m}_{L - 1}} ]\end{matrix} ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} ,$$

where the Superscript ^{T} denotes a matrix transposition operation. Note that 01, O₂ oversampling factors are assumed for the 2D DFT matrix from which matrix B is drawn. Note that W₁ is common across all layers. W_{f} is an N₃×M matrix (M<N₃) with columns selected from a critically-sampled size-N₃ DFT matrix, as follows:

$${W}_{f , l} = [ \begin{matrix}{f}_{{k}_{0}} & {f}_{{k}_{1}} & … & {f}_{{k}_{{M}^{′} - 1}} ] ,\end{matrix} 0 \leq {k}_{i} \leq {N}_{3} - 1 ,$$

$${f}_{k} = {[ \begin{matrix}1 & {e}^{- j \frac{2 π k}{{N}_{3}}} & … & {e}^{- j \frac{2 π k ( {N}_{3} - 1 )}{{N}_{3}}}\end{matrix} ]}^{T} .$$

Only the indices of the L selected columns of B are reported, along with the oversampling index taking on 0102 values. Similarly, for W_{f,l}, only the indices of the M selected columns out of the predefined size-N₃ DFT matrix are reported. In the sequel the indices of the M dimensions are referred to as the selected frequency domain (FD) basis indices. Hence, L, M represent the equivalent spatial and frequency dimensions after compression, respectively. Finally, the 2L×M matrix \tilde{W}₂ represents the linear combination coefficients (LCCs) of the spatial and frequency DFT-basis vectors. Both \tilde{W}₂, W_{f} are selected independent for different layers. Magnitude and phase values of an approximately β fraction of the 2 LM available coefficients are reported to the gNB (β<1) as part of the CSI report. Coefficients with zero magnitude are indicated via a per-layer bitmap, with the strongest coefficient amplitude set to one, and an index of the strongest coefficient reported. No amplitude or phase information is explicitly reported for this coefficient. Amplitude and phase values of a maximum of ┌2βLM┐−1 coefficients, compared with 2N₁N₂×N₃−1 coefficients of a theoretical design.

For the Type-II Port Selection codebook (Rel. 16), only K (where K≤2N₁N₂) beamformed CSI-RS ports are utilized in DL transmission, in order to reduce complexity. The K×N₃ codebook matrix per layer takes on the form:

$${W}_{l} = {W}_{1}^{PS} {\tilde{W}}_{2 , l} {W}_{f , l}^{H} .$$

Here, \tilde{W}_{2,l} and W_{f,l} follow the same structure as the conventional NR (Rel. 16) Type-II Codebook, where both are layer specific. The matrix

$${W}_{1}^{PS}$$

is a K×2L block-diagonal matrix with the same structure as that in the NR (Rel. 15) Type-II Port Selection codebook.

The NR (Rel. 17) Type-II Port Selection codebook follows a similar structure as that of Rel. 15 and Rel. 16 port-selection codebooks, as follows:

$${W}_{l} = {\overline{W}}_{1}^{PS} {\tilde{W}}_{2 , l} {W}_{f , l}^{H} .$$

However, unlike Rel. 15 and Rel. 16 Type-II port-selection codebooks, the port-selection matrix

$${\overline{W}}_{1}^{PS}$$

supports free selection of K ports, or more precisely the K/2 ports per polarization out of the N₁N₂ CSI-RS ports per polarization, i.e.,

$$⌈ {log}_{2} ( \begin{matrix}{N}_{1} {N}_{2} \\ K / 2\end{matrix} ) ⌉$$

bits are used to identify the K/2 selected ports per polarization, wherein this selection is common across all layers. Here, \tilde{W}_{2,l} and W_{f,l} follow the same structure as the conventional NR Rel. 16 Type-II Codebook, however M is limited to 1,2 only, with the network configuring a window of size N={2,4} for M=2. Moreover, the bitmap is reported unless β=1 and the UE reports all the coefficients for a rank up to a value of two.

With reference to codebook reporting, the codebook report is partitioned into two parts based on the priority of information reported. Each part is encoded separately (Part 1 has a possibly higher code rate). Below, only the parameters for NR (Rel. 16) Type-II codebook are listed. With reference to the content of a CSI report, a Part 1 is RI+channel quality indicator (CQI)+total number of coefficients. A Part 2 is SD basis indicator+FD basis indicator/layer+bitmap/layer+coefficient amplitude info/layer+coefficient phase info/layer+strongest coefficient indicator/layer. Furthermore, Part 2 CSI can be decomposed into sub-parts, each with different priority (higher priority information listed first). Such partitioning is required to allow dynamic reporting size for a codebook based on available resources in the UL phase. Additionally, Type-II codebook is based on aperiodic CSI reporting, and only reported in PUSCH via downlink control information (DCI) triggering (one exception). Type-I codebook can be based on periodic CSI reporting (physical uplink control channel (PUCCH)) or semi-persistent CSI reporting (for PUSCH or PUCCH) or aperiodic reporting (for PUSCH).

With reference to reporting CSI report Part 2, note that multiple CSI reports may be transmitted with different priorities, as shown below in Table 1.

TABLE 1
Priority Reporting Levels for Part 2 CSI.
Priority 0:
For CSI reports 1 to N_{Rep}, Group 0 CSI for CSI reports
configured as ‘typeII-r16’ or ‘typeII-PortSelection-r16’; Part 2
wideband CSI for CSI reports configured otherwise
Priority 1:
Group 1 CSI for CSI report 1, if configured as ‘typeII-r16’ or
‘typeII-PortSelection-r16’; Part 2 sub-band CSI of even
sub-bands for CSI report 1, if configured otherwise
Priority 2:
Group 2 CSI for CSI report 1, if configured as ‘typeII-r16’ or
‘typeII-PortSelection-r16’; Part 2 sub-band CSI of odd
sub-bands for CSI report 1, if configured otherwise
Priority 3:
Group 1 CSI for CSI report 2, if configured as ‘typeII-r16’ or
‘typeII-PortSelection-r16’; Part 2 sub-band CSI of even
sub-bands for CSI report 2, if configured otherwise
Priority 4:
Group 2 CSI for CSI report 2, if configured as ‘typeII-r16’ or
‘typeII-PortSelection-r16’. Part 2 sub-band CSI of odd
sub-bands for CSI report 2, if configured otherwise
.
.
.
Priority 2N_{Rep} - 1:
Group 1 CSI for CSI report N_{Rep}, if configured as ‘typeII-r16’
or ‘typeII-PortSelection-r16’; Part 2 sub-band CSI of even
sub-bands for CSI report N_{Rep}, if configured otherwise
Priority 2N_{Rep}:
Group 2 CSI for CSI report N_{Rep}, if configured as ‘typeII-r16’
or ‘typeII-PortSelection-r16’; Part 2 sub-band CSI of odd
sub-bands for CSI report N_{Rep}, if configured otherwise

Note that the priority of the N_{Rep} CSI reports are based on the following: (1) a CSI report corresponding to one CSI reporting configuration for one cell may have higher priority compared with another CSI report corresponding to one other CSI reporting configuration for the same cell; (2) CSI reports intended to one cell may have higher priority compared with other CSI reports intended to another cell; (3) CSI reports may have higher priority based on the CSI report content (e.g., CSI reports carrying L1-RSRP information have higher priority); and (4) CSI reports may have higher priority based on their type (e.g., whether the CSI report is aperiodic, semi-persistent or periodic, and whether the report is sent via PUSCH or PUCCH, may impact the priority of the CSI report). In light of that, CSI reports may be prioritized as follows, where CSI reports with lower identifiers (IDs) have higher priority:

$${Pri}_{iCSI} ( y , k , c , s ) = 2 \cdot {N}_{cells} \cdot {M}_{s} \cdot y + {N}_{cells} \cdot {M}_{s} \cdot k + {M}_{s} \cdot c + s$$

s: CSI reporting configuration index, and Mₛ: Maximum number of CSI reporting configurations
c: Cell index, and Ncells: Number of serving cells
k: 0 for CSI reports carrying L1-RSRP or L1-SINR, 1 otherwise
y: 0 for aperiodic reports, 1 for semi-persistent reports on PUSCH, 2 for semi-persistent reports on PUCCH, 3 for periodic reports.

With reference to triggering aperiodic CSI reporting on PUSCH, a UE needs to report the needed CSI information for the network using the CSI framework in NR (Rel. 15). The triggering mechanism between a report setting and a resource setting can be summarized as shown below in Table 2.

TABLE 2
Triggering mechanism between a report setting and a resource setting.

| | | Periodic | | |
|---|---|---|---|---|
| | | CSI | | AP CSI |
| | | reporting | SP CSI reporting | Reporting |
| Time Domain | Periodic | RRC | MAC CE (PUCCH) | DCI |
| Behavior of | CSI-RS | configured | DCI (PUSCH) | |
| Resource | SP CSI- | Not | MAC CE (PUCCH) | DCI |
| Setting | RS | Supported | DCI (PUSCH) | |
| | AP CSI- | Not | Not Supported | DCI |
| | RS | Supported | | |

Moreover, all associated resource settings for a CSI report setting need to have the same time domain behavior. Periodic CSI-RS/interference management (IM) resource and CSI reports are assumed to be present and active once configured by radio resource control (RRC). Aperiodic and semi-persistent CSI-RS/IM resources and CSI reports are explicitly triggered or activated. For aperiodic CSI-RS/IM resources and aperiodic CSI reports, the triggering is performed jointly by transmitting a DCI format 0-1. Semi-persistent CSI-RS/IM resources and semi-persistent CSI reports are independently activated.

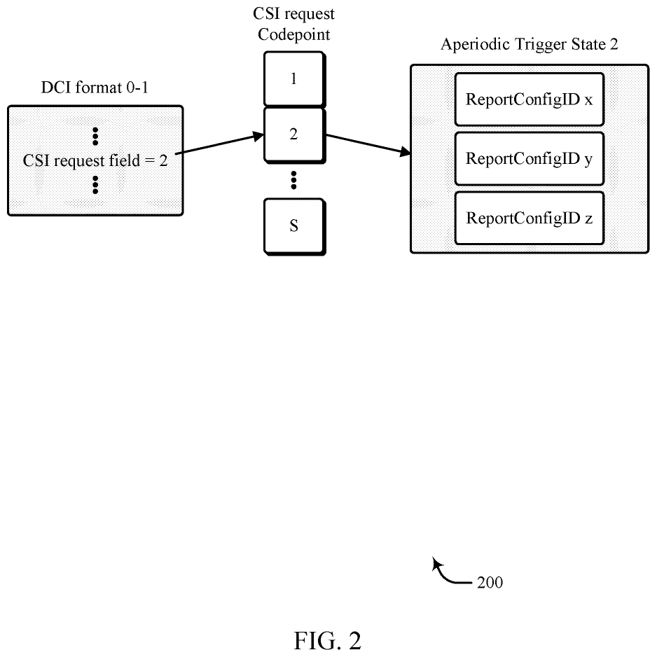

FIG. 2 illustrates an example 200 of aperiodic trigger state defining a list of CSI report settings as related to CSI enhancements for NES in accordance with aspects of the present disclosure. In this example 200, for aperiodic CSI-RS/IM resources and aperiodic CSI reports, the triggering is performed jointly by transmitting a DCI format 0-1. The DCI format 0_1 contains a CSI request field (0 to 6 bits). A non-zero request field points to an aperiodic trigger state configured by RRC. An aperiodic trigger state in turn is defined as a list of up to sixteen (16) aperiodic CSI report settings, identified by a CSI report setting ID for which the UE calculates simultaneously CSI and transmits it on the scheduled PUSCH transmission.

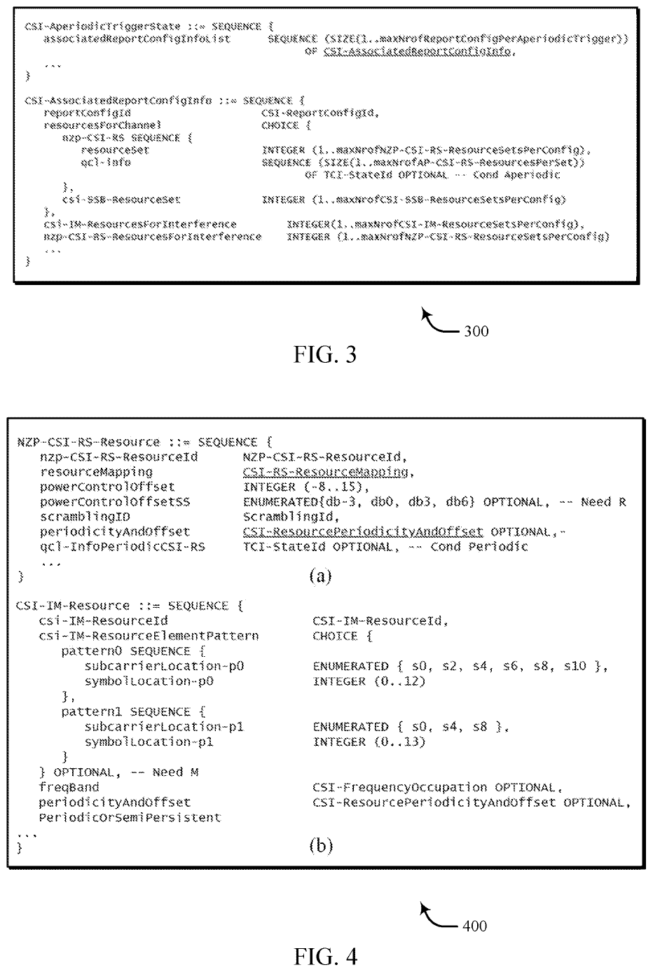

FIG. 3 illustrates an example 300 of aperiodic trigger state that indicates the resource set and QCL information as related to CSI enhancements for NES in accordance with aspects of the present disclosure. This example 300 indicates that when the CSI report setting is linked with an aperiodic resource setting (which may include multiple resource sets), the aperiodic NZP CSI-RS resource set for channel measurement, the aperiodic CSI-IM resource set (if used), and the aperiodic NZP CSI-RS resource set for IM (if used) to use for a given CSI report setting are also included in the aperiodic trigger state definition, as shown in this example 300. For aperiodic NZP CSI-RS, the QCL source to use is also configured in the aperiodic trigger state. The UE assumes that the resources used for the computation of the channel and interference can be processed with the same spatial filter (i.e. quasi-co-located with respect to “QCL-TypeD”).

FIG. 4 illustrates an example 400 of a RRC configuration for (a) an NZP-CSI-RS resource and (b) CSI-IM resource as related to CSI enhancements for NES in accordance with aspects of the present disclosure. This example 400 indicates the RRC configuration for NZP-CSI-RS/CSI-IM resources. A Table 3 below summarizes the type of UL channels used for CSI reporting as a function of the CSI codebook type.

TABLE 3
UL channels used for CSI reporting as a function of the CSI codebook
type.

| | Periodic CSI | | AP CSI |
|---|---|---|---|
| | reporting | SP CSI reporting | reporting |
| Type I WB | PUCCH Format | PUCCH Format 2 | PUSCH |
| | 2, 3, 4 | PUSCH | |
| Type I SB | | PUCCH Format 3, 4 | PUSCH |
| | | PUSCH | |
| Type II WB | | PUCCH Format 3, 4 | PUSCH |
| | | PUSCH | |
| Type II SB | | PUSCH | PUSCH |
| Type II Part 1 | | PUCCH Format 3, 4 | |
| only | | | |

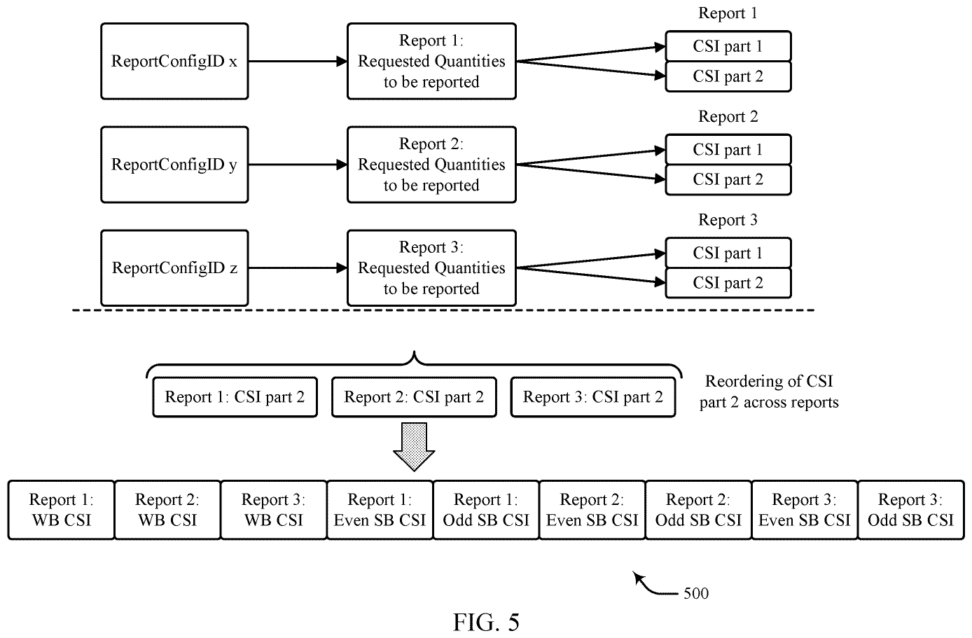

FIG. 5 illustrates an example 500 of a partial CSI omission for PUSCH-based CSI as related to timing for CSI reporting in accordance with aspects of the present disclosure. For aperiodic CSI reporting, PUSCH-based reports are divided into two CSI parts, CSI Part1 and CSI Part 2, because the size of CSI payload varies significantly, and therefore a worst-case uplink control information (UCI) payload size design would result in large overhead. CSI Part 1 has a fixed payload size (and can be decoded by the gNB without prior information) and contains the following: RI (if reported), CRI (if reported), and CQI for the first codeword; and a number of non-zero wideband amplitude coefficients per layer for Type II CSI feedback on PUSCH. CSI Part 2 has a variable payload size that can be derived from the CSI parameters in CSI Part 1 and contains PMI and the CQI for the second codeword when RI>4. For example, if the aperiodic trigger state indicated by DCI format 0_1 defines 3 report settings x, y, and z, then the aperiodic CSI reporting for CSI part 2 will be ordered as indicated in this example 500.

As described, CSI reports are prioritized according to several factors, including the time-domain behavior and physical channel, where more dynamic reports are given precedence over less dynamic reports and PUSCH has precedence over PUCCH; CSI content, where beam reports (i.e. L1-RSRP reporting) has priority over regular CSI reports; the serving cell to which the CSI corresponds (in case of carrier aggregation (CA) operation), and CSI corresponding to the PCell has priority over CSI corresponding to Scells; and the reportConfigID.

With reference to CQI reporting, a CSI report may include a CQI report quantity corresponding to channel quality assuming a maximum target transport block error rate, which indicates a modulation order, a code rate, and a corresponding spectral efficiency associated with the modulation order and code rate pair. Examples of the maximum transport block error rates are 0.1 and 0.00001. The modulation order can vary from quadrature phase-shift keying (QPSK) up to 1024QAM, whereas the code rate may vary from 30/1024 up to 948/1024. One example of a CQI table for a 4-bit CQI indicator that identifies a possible CQI value with the corresponding modulation order, code rate and efficiency is provided in Table 4 below.

TABLE 4
Example of a 4-bit CQI table.

| CQI index | modulation | code rate × 1024 | efficiency |
|---|---|---|---|
| 0 | out of range | | |
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

A CQI value may be reported in two formats: a wideband format, wherein one CQI value is reported corresponding to each PDSCH transport block, and a sub-band format, where one wideband CQI value is reported for the entire transport block, in addition to a set of sub-band CQI values corresponding to CQI sub-bands on which the transport block is transmitted. CQI sub-band sizes are configurable, and depends on the number of PRBs in a bandwidth part, as shown in Table 5 below.

TABLE 5
Configurable sub-band sizes for a given bandwidth part (BWP) size.

| Bandwidth part (PRBs) | Sub-band size (PRBs) |
|---|---|
| 24 - 72 | 4, 8 |
| 73 - 144 | 8, 16 |
| 145 - 275 | 16, 32 |

If the higher layer parameter cqi-BitsPerSubband in a CSI reporting setting CSI-ReportConfig is configured, sub-band CQI values are reported in a full form (i.e., using 4 bits for each sub-band CQI based on a CQI table, e.g., Table 4). If the higher layer parameter cqi-BitsPerSubband in CSI-ReportConfig is not configured, for each sub-band s, a 2-bit sub-band differential CQI value is reported, defined as:

$$Sub - band Offset level ( s ) = sub - band CQI index ( s ) - wideband CQI index .$$

The mapping from the 2-bit sub-band differential CQI values to the offset level is shown in Table 6 below.

TABLE 6
Mapping sub-band differential CQI value to offset level.

| Sub-band differential CQI value | Offset level |
|---|---|
| 0 | 0 |
| 1 | 1 |
| 2 | ≥2 |
| 3 | ≤-1 |

Aspects of CSI enhancements for NES include and/or are directed to antenna panels and/or ports, quasi-collocation, transmission configuration indication (TCI) state, and spatial relation. In some implementations, the terms antenna, panel, and antenna panel are used interchangeably. An antenna panel may be hardware that is used for transmitting and/or receiving radio signals at frequencies lower than 6 GHz (e.g., frequency range 1 (FR1)), or higher than 6 GHz (e.g., frequency range 2 (FR2)) or millimeter wave (mmWave). In some implementations, an antenna panel includes an array of antenna elements, where each antenna element is connected to hardware, such as a phase shifter that allows a control module to apply spatial parameters for transmission and/or reception of signals. The resulting radiation pattern is called a beam, which may or may not be unimodal and allows the device to amplify signals that are transmitted or received from spatial directions.

In one or more implementations, an antenna panel may be virtualized as an antenna port in the specifications. An antenna panel can be connected to a baseband processing module through a radio frequency (RF) chain for each of transmission (egress) and reception (ingress) directions. A capability of a device in terms of the number of antenna panels, their duplexing capabilities, their beamforming capabilities, and so on, may or may not be transparent to other devices. In some implementations, capability information is communicated via signaling or, in some implementations, capability information is provided to devices without a need for signaling. In the event that such information is available to other devices, it can be used for signaling or local decision making.

In one or more implementations, a device (e.g., a UE, a network node) antenna panel may be a physical or logical antenna array comprising a set of antenna elements or antenna ports that share a common or a significant portion of an RF chain (e.g., in-phase/quadrature (I/Q) modulator, analog to digital (A/D) converter, local oscillator, phase shift network). The device antenna panel (or device panel) may be a logical entity with physical device antennas mapped to the logical entity. The mapping of physical device antennas to the logical entity can be based on device implementation. Communicating (e.g., receiving or transmitting) on at least a subset of antenna elements or antenna ports active for radiating energy (also referred to herein as active elements) of an antenna panel requires biasing or powering of the RF chain, which results in current drain or power consumption in the device associated with the antenna panel, including power amplifier and/or low noise amplifier (LNA) power consumption associated with the antenna elements or antenna ports. The phrase “active for radiating energy,” as used herein is not meant to be limited to a transmit function, but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In one or more implementations, and depending on the particular device implementation, a device panel can have at least one of the following functionalities as an operational role: a unit of an antenna group to control its transmit beam independently, a unit of an antenna group to control its transmission power independently, and/or a unit of an antenna group to control its transmission timing independently. The device panel may be transparent to a gNB. For certain condition(s), a gNB or a network node can assume the mapping between the physical antennas of a device to the logical entity “device panel” may not be changed. For example, the condition may include until the next update or report from a device, or include a duration of time over which the gNB assumes there will be no change to the mapping. A device may report its capability with respect to the device panel to the gNB or network. The device capability can include at least the number of device panels. In an implementation, the device may support UL transmission from one beam within a panel, and with multiple panels, more than one beam (e.g., one beam per panel) may be used for UL transmission. In another implementation, more than one beam per panel may be supported or used for UL transmission.

In some described implementations, an antenna port is defined such that the channel over which a symbol on the antenna port is conveyed can be inferred from the channel over which another symbol on the same antenna port is conveyed. Two antenna ports are quasi co-located (QCL) if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and/or spatial receive parameters. Two antenna ports may be quasi-located with respect to a subset of the large-scale properties, and a different subset of large-scale properties can be indicated by a QCL type. The QCL type can indicate which channel properties are the same between the two reference signals (e.g., on the two antenna ports). Thus, the reference signals can be linked to each other with respect to what the UE can assume about their channel statistics or QCL properties. For example, the qcl-type can be one of the following values: QCL-TypeA: {Doppler shift, Doppler spread, average delay, delay spread}; QCL-TypeB: {Doppler shift, Doppler spread}; QCL-TypeC: {Doppler shift, average delay}; QCL-TypeD: {Spatial Rx parameter}.

Spatial receive parameters can include one or more of angle of arrival (AoA,) dominant AoA, average AoA, angular spread, power angular spectrum (PAS) of AoA, average AoD (angle of departure), PAS of AoD, transmit and/or receive channel correlation, transmit and/or receive beamforming, spatial channel correlation, etc. The QCL-TypeA, QCL-TypeB and QCL-TypeC may be applicable for all carrier frequencies, but the QCL-TypeD may be applicable only in higher carrier frequencies (e.g., mmWave, FR2 and beyond), where essentially the UE may not be able to perform omni-directional transmission (i.e., the UE would need to form beams for directional transmission). For a QCL-TypeD between two reference signals A and B, the reference signal A is considered to be spatially co-located with reference signal B and the UE may assume that the reference signals A and B can be received with the same spatial filter (e.g., with the same receive (RX) beamforming weights).

As described in this disclosure, an antenna port may be a logical port that corresponds to a beam (resulting from beamforming), or may correspond to a physical antenna on a device. In one or more implementations, a physical antenna can map directly to a single antenna port, in which an antenna port corresponds to an actual physical antenna. Alternately, a set or subset of physical antennas, or an antenna set or antenna array or antenna sub-array, may be mapped to one or more antenna ports after applying complex weights, a cyclic delay, or both to the signal on each physical antenna. The physical antenna set may have antennas from a single module or panel, or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some described implementations, a TCI-state associated with a target transmission can indicate parameters for configuring a quasi-collocation relationship between the target transmission (e.g., a target RS of DM-RS ports of the target transmission during a transmission occasion) and one or more source reference signals (e.g., synchronization signal block (SSB), CSI-RS, and/or sounding reference signal (SRS)) with respect to quasi co-location type parameters indicated in the corresponding TCI state. The TCI describes which reference signals are used as a QCL source, and what QCL properties can be derived from each reference signal. A device can receive a configuration of a plurality of transmission configuration indicator states for a serving cell for transmissions on the serving cell. In some of the described implementations, a TCI state includes at least one source RS to provide a reference (UE assumption) for determining QCL and/or a spatial filter.

In one or more implementations, spatial relation information associated with a target transmission can indicate parameters for configuring a spatial setting between the target transmission and a reference RS (e.g., SSB, CSI-RS, and/or SRS). For example, the device can transmit the target transmission with the same spatial domain filter used for reception of the reference RS (e.g., DL RS such as SSB or CSI-RS). In another example, the device may transmit the target transmission with the same spatial domain transmission filter used for the transmission of the reference RS (e.g., UL RS, such as SRS). A device can receive a configuration of multiple spatial relation information configurations for a serving cell for transmissions on the serving cell.

In some described implementations, an UL TCI state is provided if a device is configured with separate DL/UL TCI by RRC signaling. The UL TCI state can include a source reference signal which provides a reference for determining an UL spatial domain transmission filter for the UL transmission (e.g., dynamic-grant or configured-grant based PUSCH, dedicated PUCCH resources) in a component carrier (CC), or across a set of configured CCs and/or BWPs.

In some described implementations, a joint DL/UL TCI state is provided if the device is configured with joint DL/UL TCI by RRC signaling (e.g., configuration of joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides a QCL Type-D indication (e.g., for device-dedicated physical downlink control channel (PDCCH) and/or physical downlink shared channel (PDSCH)) and is used to determine UL spatial transmission filter (e.g., for UE-dedicated PUSCH and/or PUCCH) for a CC, or across a set of configured CCs and/or BWPs. In an example, the UL spatial transmission filter is derived from the RS of DL QCL Type-D in the joint TCI state. The spatial setting of the UL transmission may be according to the spatial relation with a reference to the source RS configured with qcl-Type set to “typed” in the joint TCI state.

In aspects of CSI enhancements for NES, the following notations are used interchangeably, including transmit-receive point (TRP), panel, set of antennas, set of antenna ports, uniform linear array, cell, node, radio head, communication (e.g., signals/channels) associated with a control resource set (CORESET), communication associated with a TCI state from a transmission configuration of at least two TCI states. The codebook type used for PMI reporting is arbitrary, and flexible in the use of different codebook types (e.g., Type-II Rel. 16 codebook, Type-II Rel. 17 codebook, Type-II Rel. 18 codebook, etc.).

With reference to activating the NES mode in a CSI framework, in an implementation for DCI indicates NES, the NES mode is activated via PDCCH signaling (e.g., as part of DCI transmitted to a UE). In an example, the DCI corresponds to a DCI format for scheduling physical uplink shared channel (PUSCH) (e.g., DCI format 0_2 for scheduling PUSCH). In another example, the DCI includes a parameter for activating NES (e.g., one bit of the CSI request field). In another example, the CSI request includes a CSI reporting configuration ID selected from a set in a CSI reporting trigger list. In an implementation for medium access control element (MAC CE) indicates NES, the NES mode is indicated via MAC CE signaling associated with a downlink transmission, such as indications to the UE from the network (e.g., a network entity, network node, base station, gNB, repeater, transmission reception point (TRP), etc.). In an implementation for radio resource control (RRC) indicates NES, the NES mode is indicated via an RRC parameter in one of the CSI reporting setting, the CSI resource setting, the NZP CSI-RS resource configuration, and/or an NZP CSI-RS resource set configuration.

With reference to a CSI reporting configuration in the NES mode, an implementation utilizes an aperiodic CSI report configuration to override configuration parameters of a periodic or semi-persistent CSI report configuration. An aperiodic CSI reporting configuration ID indicated in the CSI reporting trigger list refers to at least one of a periodic CSI reporting configuration or a semi-persistent CSI reporting configuration corresponding to an NZP CSI-RS resource configuration, and the corresponding NZP CSI-RS resource is used as a channel measurement resource. In another implementation for rank restriction in NES, a UE receiving an indication of an NES mode cannot report an RI with a value larger than a specific threshold. In an example, a value of the specific threshold is two. In another example, a specific threshold of RI is in a form of a value of an RI restriction, where only a subset of the set of possible values corresponding to RI restriction parameters that restrict at least one rank indicator values are activated.

In another implementation as related to the NES mode triggers quantities corresponding to port selection, CRI, or RSRP, a UE receiving an indication of the NES mode is configured with a CSI reporting setting that includes a set of report quantities corresponding to CSI that are associated with the NES mode. In an example, the UE reports a quantity as a subset of antennas that can be turned off. A report quantity corresponding to NES is activated (e.g., a NES quantity that includes a sub-selection of at least one of a set of CSI-RS ports, a set of slots, and/or a set of frequency sub-bands). In another example, a report quantity with at least a CRI is included in a configured report quantity, where the CRI corresponds to a CSI-RS resource ID with a given number of ports. In another example, a report quantity with at least L1-RSRP is included in an activated report quantity, where the L1-RSRP corresponds to at least one CSI-RS resource with a given number of ports.

In another implementation for NES mode associated with PS codebook, a UE receiving an indication of an NES mode is configured with a port selection codebook (e.g., eType-II Rel-16 port-selection codebook or FeType-II Rel-17 port-selection codebook), where a port selection indication parameter returned by the UE indicates a set of CSI-RS ports to be utilized by the UE in a consequent CSI-RS transmission. In an example, only a subset of the port-selection codebook is reported. In another example, only port-selection parameters corresponding to a first group (Group 0) of a second part of an enhanced (or Further enhanced) Type-II port selection codebook are reported. In another example, only parameters corresponding up to a first group (Group 0) of a second part of an enhanced (or Further enhanced) Type-II port selection codebook are reported.

With reference to CSI resource setting in the NES mode, an implementation includes the NES mode indicated per CSI-RS resource or resource set. A configuration corresponding to an NZP CSI-RS resource includes a parameter that indicates the NES mode is activated. In an example, the NES mode is activated in a form of a higher-layer parameter (e.g., a RRC parameter, in the NZP CSI-RS resource configuration). In another example, the NES mode is activated in a form of a higher-layer parameter (e.g., RRC parameter, in the NZP CSI-RS resource set configuration).

In an implementation directed to CSI-RS resource grouping to multiple CSI-RS port groups, the NZP CSI-RS resource configuration includes at least one parameter corresponding to a grouping of the NZP CSI-RS ports into two or more groups, where each group of NZP CSI-RS ports is associated with an ID. In an example, the UE selects one group of the two or more NZP CSI-RS ports, where the ID of the UE-selected group of NZP CSI-RS resources is reported back as a value of the CRI quantity of a CSI report. In another example, the UE is configured with one NZP CSI-RS resource. In another example a same NZP CSI-RS resource (e.g., a group of ports) is associated with two or more NZP CSI-RS resource IDs, where each NZP CSI-RS resource ID corresponds to a distinct group of NZP CSI-RS ports. In another example, the UE is configured with a reporting quantity that includes L1-RSRP, where the UE reports multiple RSRP values corresponding to the two or more NZP CSI-RS resource IDs. In another example, all ports of an NZP CSI-RS resource are partitioned into the two or more groups of the NZP CSI-RS ports, where each NZP CSI-RS port is associated with no more than one group of NZP CSI-RS ports.

In an implementation related to reporting a combinatorial value corresponding to port selection, the UE is configured with a CSI reporting setting with a codebook type set to FeType-II Rel-17 Port Selection codebook, and when the NES mode is activated, a parameter corresponding to reporting a subset of the set of ports of the NZP CSI-RS resource is reported in a form of an index. In an example, the index takes on up to

$$( \begin{matrix}{P}_{CSI - RS} / 2 \\ L\end{matrix} )$$

values from 0, 1, 2, . . . ,

$$( \begin{matrix}{P}_{CSI - RS} / 2 \\ L\end{matrix} ) - 1$$

corresponding to a selected subset of L beams, i.e., selected ports, from a set of P_{CSI-RS}/2 ports per polarization (i.e., a total of 2L beams from a set of P_{CSI-RS} ports across both polarizations), where a combinatorial function

$$( \begin{matrix}x \\ y\end{matrix} )$$

is a standard combination function. In an implementation related to reporting a selected set of ports using combinatorial values, a bitmap, etc., the UE is configured with reporting a quantity corresponding to a selection of a subset of the set of NZP CSI-RS ports. In an example, the selection is in a form of a combinatorial function

$$( \begin{matrix}x \\ y\end{matrix} ) ,$$

where x represents a total number of ports and y represents a number of the selected ports. In another example, the selection is in a form of a codebook corresponding to a set of pre-defined groups of ports. In another example, the selection is in a form of an indication of a number of selected ports, where a pre-defined set of ports for each selection of a number of selected ports is defined. In another example, the selection is in a form of a bitmap of a size corresponding to a number of ports, where a bit-value of one at an i^{th} entry of the bitmap indicates that an i^{th} port is selected.

In an implementation related to CSI-RS periodicity and frequency density adjusted under NES mode, the UE is configured with at least one of a CSI-RS periodicity or a frequency density corresponding to NES mode. In an example, a periodicity value corresponding to the NES mode being activated is larger than a periodicity value corresponding to the NES mode being deactivated. In another example, a frequency density value corresponding to the NES mode being activated is smaller than a frequency density value corresponding to the NES mode being deactivated.

With reference to CQI enhancements for NES mode, an implementation is related to multiple CQI values corresponding to a same PMI value. The CSI reporting with report quantity corresponding to a combination of one or more of LI, CQI, or RI are reported in the NES mode, where the UE reports back an updated CQI value based on a prior PMI. In an example, the UE reports back multiple CQI values across multiple CSI reporting instants, where each CQI value of the multiple CQI values corresponds to a channel quality measured at a corresponding instant based on a common PMI value that is reported prior to reporting any of the multiple CQI values. In an implementation related to two CQI values corresponding to the NES mode on and off, two CQI values are reported, including a first CQI value corresponding to the NES mode being activated, and a second CQI value corresponding to the NES mode being deactivated.

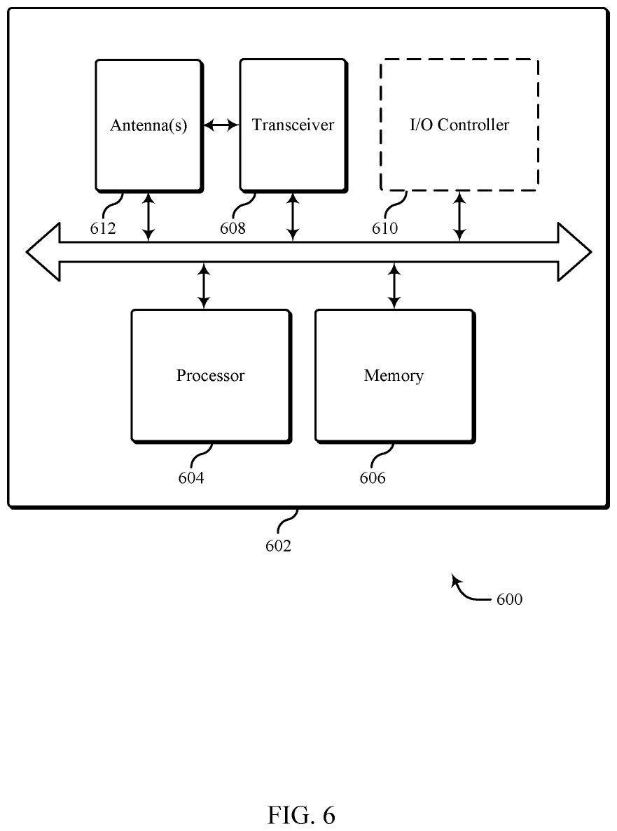

FIG. 6 illustrates an example of a block diagram 600 of a device 602 that supports CSI enhancements for NES in accordance with aspects of the present disclosure. The device 602 may be an example of UE 104 as described herein. The device 602 may support wireless communication with one or more network entities 102, UEs 104, or any combination thereof. The device 602 may include components for bi-directional communications including components for transmitting and receiving communications, such as a processor 604, a memory 606, a transceiver 608, and an I/O controller 610. These components may be in electronic communication or otherwise coupled (e.g., operatively, communicatively, functionally, electronically, electrically) via one or more interfaces (e.g., buses).

The processor 604, the memory 606, the transceiver 608, or various combinations thereof or various components thereof may be examples of means for performing various aspects of the present disclosure as described herein. For example, the processor 604, the memory 606, the transceiver 608, or various combinations or components thereof may support a method for performing one or more of the operations described herein.

In some implementations, the processor 604, the memory 606, the transceiver 608, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 604 and the memory 606 coupled with the processor 604 may be configured to perform one or more of the functions described herein (e.g., executing, by the processor 604, instructions stored in the memory 606).

For example, the processor 604 may support wireless communication at the device 602 in accordance with examples as disclosed herein. The processor 604 may be configured as or otherwise support a means for receiving a first signaling from a network entity corresponding to an indication of a NES mode, the NES mode activated and associated with a CSI reporting setting that includes a configuration for at least one of a reduced CSI feedback or a reduced number of CSI-RS ports per NZP CSI-RS resource; and transmitting a second signaling as a CSI report based at least in part on the CSI reporting setting associated with the NES mode.

Additionally, the processor 604 may be configured as or otherwise support any one or combination of the first signaling is received from the network entity indicating that the NES mode is activated for the network entity, or for one or more network entities in a wireless communications network that includes the network entity. The NES mode is activated via a parameter of one of the CSI reporting setting, a CSI resource setting, or an NZP CSI-RS resource setting. The NES mode is activated via DCI corresponding to scheduling a PUSCH. An aperiodic CSI reporting setting is indicated in a CSI reporting trigger list associated with a CSI request field of the DCI. The identifier identifies at least one of a periodic CSI reporting setting or a semi-persistent CSI reporting setting corresponding to an NZP CSI-RS resource setting. The CSI report includes a RI value that is smaller than or equal to a threshold RI value associated with the NES mode. A UE receives the indication of the NES mode and transmits the CSI report, and the method further comprising configuring the UE with a CSI reporting setting that includes a set of report quantities associated with the NES mode. The set of report quantities includes at least one of: an indication of a sub-selection of at least one of a set of CSI-RS ports, a set of slots, or a set of frequency sub-bands; a CRI corresponding to a CSI-RS resource identifier with a designated number of ports; or LI-RSRP corresponding to at least one CSI-RS resource with the designated number of ports. A UE receives the indication of the NES mode and transmits the CSI report, and the method further comprising configuring the UE with a port selection codebook that includes a parameter that identifies a subset of the CSI-RS ports associated with the NES mode. An NZP CSI-RS resource configuration associated with the NES mode includes at least one parameter corresponding to a grouping of the NZP CSI-RS ports into two or more groups, each associated with an identifier of a respective group. The CSI report includes a CRI report quantity value as an index corresponding to a selected group of the NZP CSI-RS ports. A UE receives the indication of the NES mode and transmits the CSI report, and the method further comprising: configuring the UE with the NZP CSI-RS resource that includes at least one of: a higher periodicity value associated with the NES mode than that of a periodicity value not associated with the NES mode; or a lower frequency density value associated with the NES mode than that of a frequency density value not associated with the NES mode. The CSI report includes a CQI value based at least in part on a PMI value reported in a prior CSI report. The NES mode is associated with a single layer corresponding to the CSI, an identification of the single layer is signaled in a form of a LI value of the CSI report associated with the NES mode. The CSI report includes two CQI values including a first CQI value associated with the NES mode being activated, and a second CQI value associated with the NES mode being deactivated.

Additionally, or alternatively, the device 602, in accordance with examples as disclosed herein, may include a processor and a memory coupled with the processor, the processor configured to cause the apparatus to: receive a first signaling from a network entity corresponding to an indication of a NES mode, the NES mode activated and associated with a CSI reporting setting that includes a configuration for at least one of a reduced CSI feedback or a reduced number of CSI-RS ports per NZP CSI-RS resource; and transmit a second signaling as a CSI report based at least in part on the CSI reporting setting associated with the NES mode.

Additionally, the wireless communication at the device 602 may include any one or combination of the processor is configured to cause the apparatus to receive the first signaling from the network entity indicating that the NES mode is activated for the network entity, or for one or more network entities in a wireless communications network that includes the network entity. The NES mode is activated via a parameter of one of the CSI reporting setting, a CSI resource setting, or an NZP CSI-RS resource setting. The NES mode is activated via DCI corresponding to scheduling a PUSCH. An identifier of an aperiodic CSI reporting setting is indicated in a CSI reporting trigger list associated with a CSI request field of the DCI. The identifier identifies at least one of a periodic CSI reporting setting or a semi-persistent CSI reporting setting corresponding to an NZP CSI-RS resource setting. The CSI report includes a RI value that is smaller than or equal to a threshold RI value associated with the NES mode. The processor is configured to cause the apparatus to be configured with a CSI reporting setting that includes a set of report quantities associated with the NES mode. The set of report quantities includes at least one of: an indication of a sub-selection of at least one of a set of CSI-RS ports, a set of slots, or a set of frequency sub-bands; a CRI corresponding to a CSI-RS resource identifier with a designated number of ports; or L1-RSRP corresponding to at least one CSI-RS resource with the designated number of ports. The processor is configured to cause the apparatus to be configured with a port selection codebook that includes a parameter that identifies a subset of the CSI-RS ports associated with the NES mode. An NZP CSI-RS resource configuration associated with the NES mode includes at least one parameter corresponding to a grouping of the NZP CSI-RS ports into two or more groups, each associated with an identifier of a respective group. The CSI report includes a CRI report quantity value as an index corresponding to a selected group of the NZP CSI-RS ports. The processor is configured to cause the apparatus to be configured with the NZP CSI-RS resource that includes at least one of: a higher periodicity value associated with the NES mode than that of a periodicity value not associated with the NES mode; or a lower frequency density value associated with the NES mode than that of a frequency density value not associated with the NES mode. The CSI report includes a CQI value based at least in part on a PMI value reported in a prior CSI report. The NES mode is associated with a single layer corresponding to the CSI, an identification of the single layer is signaled in a form of a LI value of the CSI report associated with the NES mode. The CSI report includes two CQI values including a first CQI value associated with the NES mode being activated, and a second CQI value associated with the NES mode being deactivated.

The processor 604 of the device 602, such as a UE 104, may support wireless communication in accordance with examples as disclosed herein. The processor 604 includes at least one controller coupled with at least one memory, and is configured to or operable to cause the processor to receive a first signaling from a network entity corresponding to an indication of a NES mode, the NES mode activated and associated with a CSI reporting setting that includes a configuration for at least one of a reduced CSI feedback or a reduced number of CSI-RS ports per NZP CSI-RS resource; and transmit a second signaling as a CSI report based at least in part on the CSI reporting setting associated with the NES mode.

The processor 604 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 604 may be configured to operate a memory array using a memory controller. In some other implementations, a memory controller may be integrated into the processor 604. The processor 604 may be configured to execute computer-readable instructions stored in a memory (e.g., the memory 606) to cause the device 602 to perform various functions of the present disclosure.

The memory 606 may include random access memory (RAM) and read-only memory (ROM). The memory 606 may store computer-readable, computer-executable code including instructions that, when executed by the processor 604 cause the device 602 to perform various functions described herein. The code may be stored in a non-transitory computer-readable medium such as system memory or another type of memory. In some implementations, the code may not be directly executable by the processor 604 but may cause a computer (e.g., when compiled and executed) to perform functions described herein. In some implementations, the memory 606 may include, among other things, a basic I/O system (BIOS) which may control basic hardware or software operation such as the interaction with peripheral components or devices.

The I/O controller 610 may manage input and output signals for the device 602. The I/O controller 610 may also manage peripherals not integrated into the device M02. In some implementations, the I/O controller 610 may represent a physical connection or port to an external peripheral. In some implementations, the I/O controller 610 may utilize an operating system such as iOS®, ANDROID®, MS-DOS®, MS-WINDOWS®, OS/2®, UNIX®, LINUX®, or another known operating system. In some implementations, the I/O controller 610 may be implemented as part of a processor, such as the processor 604. In some implementations, a user may interact with the device 602 via the I/O controller 610 or via hardware components controlled by the I/O controller 610.

In some implementations, the device 602 may include a single antenna 612. However, in some other implementations, the device 602 may have more than one antenna 612 (i.e., multiple antennas), including multiple antenna panels or antenna arrays, which may be capable of concurrently transmitting or receiving multiple wireless transmissions. The transceiver 608 may communicate bi-directionally, via the one or more antennas 612, wired, or wireless links as described herein. For example, the transceiver 608 may represent a wireless transceiver and may communicate bi-directionally with another wireless transceiver. The transceiver 608 may also include a modem to modulate the packets, to provide the modulated packets to one or more antennas 612 for transmission, and to demodulate packets received from the one or more antennas 612.

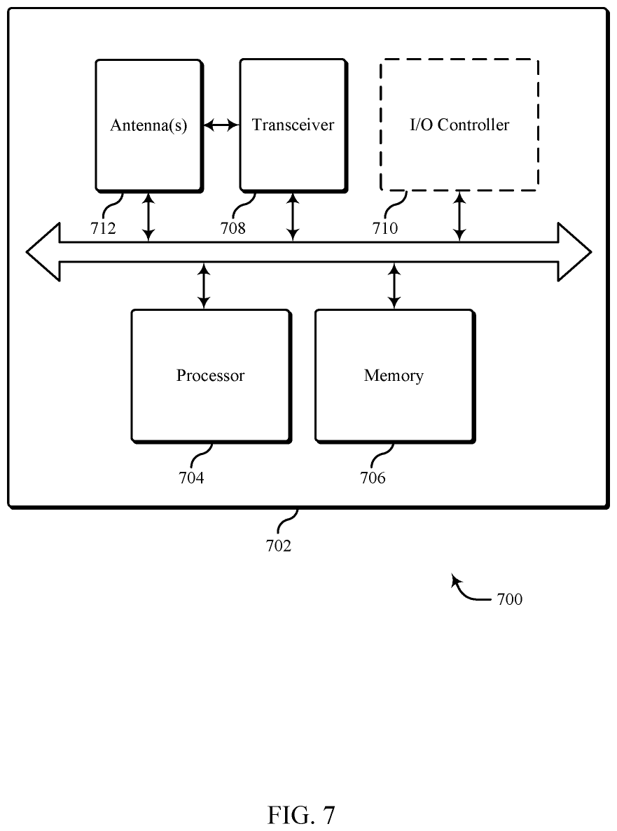

FIG. 7 illustrates an example of a block diagram 700 of a device 702 that supports CSI enhancements for NES in accordance with aspects of the present disclosure. The device 702 may be an example of a network entity 102 (e.g., a network node, or a network entity at a network node) as described herein. The device 702 may support wireless communication with one or more network entities 102, UEs 104, or any combination thereof. The device 702 may include components for bi-directional communications including components for transmitting and receiving communications, such as a processor 704, a memory 706, a transceiver 708, and an I/O controller 710. These components may be in electronic communication or otherwise coupled (e.g., operatively, communicatively, functionally, electronically, electrically) via one or more interfaces (e.g., buses).

The processor 704, the memory 706, the transceiver 708, or various combinations thereof or various components thereof may be examples of means for performing various aspects of the present disclosure as described herein. For example, the processor 704, the memory 706, the transceiver 708, or various combinations or components thereof may support a method for performing one or more of the operations described herein.

In some implementations, the processor 704, the memory 706, the transceiver 708, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 704 and the memory 706 coupled with the processor 704 may be configured to perform one or more of the functions described herein (e.g., executing, by the processor 704, instructions stored in the memory 706).

For example, the processor 704 may support wireless communication at the device 702 in accordance with examples as disclosed herein. The processor 704 may be configured as or otherwise support a means for transmitting a first signaling corresponding to an indication of a NES mode, the NES mode activated and associated with a CSI reporting setting that includes a configuration for at least one of a reduced CSI feedback or a reduced number of CSI-RS ports per NZP CSI-RS resource; and receiving a second signaling as a CSI report based at least in part on the CSI reporting setting associated with the NES mode.

Additionally, the processor 704 may be configured as or otherwise support any one or combination of the first signaling is transmitted to a UE from a network entity indicating that the NES mode is activated for the network entity, or for one or more network entities in a wireless communications network that includes the network entity. The NES mode is activated via a parameter of one of the CSI reporting setting, a CSI resource setting, or an NZP CSI-RS resource setting. The NES mode is activated via DCI corresponding to scheduling a PUSCH. An identifier of an aperiodic CSI reporting setting is indicated in a CSI reporting trigger list associated with a CSI request field of the DCI, the identifier identifying at least one of a periodic CSI reporting setting or a semi-persistent CSI reporting setting corresponding to an NZP CSI-RS resource setting. The CSI report includes a RI value that is smaller than or equal to a threshold RI value associated with the NES mode. A CSI reporting setting includes a set of report quantities associated with the NES mode, the set of report quantities including at least one of: an indication of a sub-selection of at least one of a set of CSI-RS ports, a set of slots, or a set of frequency sub-bands; a CRI corresponding to a CSI-RS resource identifier with a designated number of ports; or L1-RSRP corresponding to at least one CSI-RS resource with the designated number of ports. A port selection codebook includes a parameter that identifies a subset of the CSI-RS ports associated with the NES mode. An NZP CSI-RS resource configuration associated with the NES mode includes at least one parameter corresponding to a grouping of the NZP CSI-RS ports into two or more groups, each associated with an identifier of a respective group. The CSI report includes a CRI report quantity value as an index corresponding to a selected group of the NZP CSI-RS ports. The NZP CSI-RS resource includes at least one of: a higher periodicity value associated with the NES mode than that of a periodicity value not associated with the NES mode; or a lower frequency density value associated with the NES mode than that of a frequency density value not associated with the NES mode. The CSI report includes a CQI value based at least in part on a PMI value reported in a prior CSI report. The NES mode is associated with a single layer corresponding to the CSI, an identification of the single layer is signaled in a form of a LI value of the CSI report associated with the NES mode. The CSI report includes two CQI values including a first CQI value associated with the NES mode being activated, and a second CQI value associated with the NES mode being deactivated.

Additionally, or alternatively, the device 702, in accordance with examples as disclosed herein, may include a processor and a memory coupled with the processor, the processor configured to cause the apparatus to: transmit a first signaling corresponding to an indication of a NES mode, the NES mode activated and associated with a CSI reporting setting that includes a configuration for at least one of a reduced CSI feedback or a reduced number of CSI-RS ports per NZP CSI-RS resource; and receive a second signaling as a CSI report based at least in part on the CSI reporting setting associated with the NES mode.

Additionally, the wireless communication at the device 702 may include any one or combination of the apparatus is a network entity and the NES mode is activated for the network entity, or for one or more network entities in a wireless communications network that includes the network entity. The NES mode is activated via a parameter of one of the CSI reporting setting, a CSI resource setting, or an NZP CSI-RS resource setting. The NES mode is activated via DCI corresponding to scheduling a PUSCH. An identifier of an aperiodic CSI reporting setting is indicated in a CSI reporting trigger list associated with a CSI request field of the DCI, the identifier identifying at least one of a periodic CSI reporting setting or a semi-persistent CSI reporting setting corresponding to an NZP CSI-RS resource setting. The CSI report includes a RI value that is smaller than or equal to a threshold RI value associated with the NES mode. A CSI reporting setting includes a set of report quantities associated with the NES mode, the set of report quantities including at least one of: an indication of a sub-selection of at least one of a set of CSI-RS ports, a set of slots, or a set of frequency sub-bands; a CRI corresponding to a CSI-RS resource identifier with a designated number of ports; or L1-RSRP corresponding to at least one CSI-RS resource with the designated number of ports. A port selection codebook includes a parameter that identifies a subset of the CSI-RS ports associated with the NES mode. An NZP CSI-RS resource configuration associated with the NES mode includes at least one parameter corresponding to a grouping of the NZP CSI-RS ports into two or more groups, each associated with an identifier of a respective group. The CSI report includes a CRI report quantity value as an index corresponding to a selected group of the NZP CSI-RS ports. The NZP CSI-RS resource includes at least one of: a higher periodicity value associated with the NES mode than that of a periodicity value not associated with the NES mode; or a lower frequency density value associated with the NES mode than that of a frequency density value not associated with the NES mode. The CSI report includes a CQI value based at least in part on a PMI value reported in a prior CSI report. The NES mode is associated with a single layer corresponding to the CSI, an identification of the single layer is signaled in a form of a LI value of the CSI report associated with the NES mode. The CSI report includes two CQI values including a first CQI value associated with the NES mode being activated, and a second CQI value associated with the NES mode being deactivated.

The processor 704 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 704 may be configured to operate a memory array using a memory controller. In some other implementations, a memory controller may be integrated into the processor 704. The processor 704 may be configured to execute computer-readable instructions stored in a memory (e.g., the memory 706) to cause the device 702 to perform various functions of the present disclosure.

The memory 706 may include random access memory (RAM) and read-only memory (ROM). The memory 706 may store computer-readable, computer-executable code including instructions that, when executed by the processor 704 cause the device 702 to perform various functions described herein. The code may be stored in a non-transitory computer-readable medium such as system memory or another type of memory. In some implementations, the code may not be directly executable by the processor 704 but may cause a computer (e.g., when compiled and executed) to perform functions described herein. In some implementations, the memory 706 may include, among other things, a basic I/O system (BIOS) which may control basic hardware or software operation such as the interaction with peripheral components or devices.

The I/O controller 710 may manage input and output signals for the device 702. The I/O controller 710 may also manage peripherals not integrated into the device 702. In some implementations, the I/O controller 710 may represent a physical connection or port to an external peripheral. In some implementations, the I/O controller 710 may utilize an operating system such as iOS®, ANDROID®, MS-DOS®, MS-WINDOWS®, OS/2®, UNIX®, LINUX®, or another known operating system. In some implementations, the I/O controller 710 may be implemented as part of a processor, such as the processor 704. In some implementations, a user may interact with the device 702 via the I/O controller 710 or via hardware components controlled by the I/O controller 710.

In some implementations, the device 702 may include a single antenna 712. However, in some other implementations, the device 702 may have more than one antenna 712 (i.e., multiple antennas), including multiple antenna panels or antenna arrays, which may be capable of concurrently transmitting or receiving multiple wireless transmissions. The transceiver 708 may communicate bi-directionally, via the one or more antennas 712, wired, or wireless links as described herein. For example, the transceiver 708 may represent a wireless transceiver and may communicate bi-directionally with another wireless transceiver. The transceiver 708 may also include a modem to modulate the packets, to provide the modulated packets to one or more antennas 712 for transmission, and to demodulate packets received from the one or more antennas 712.

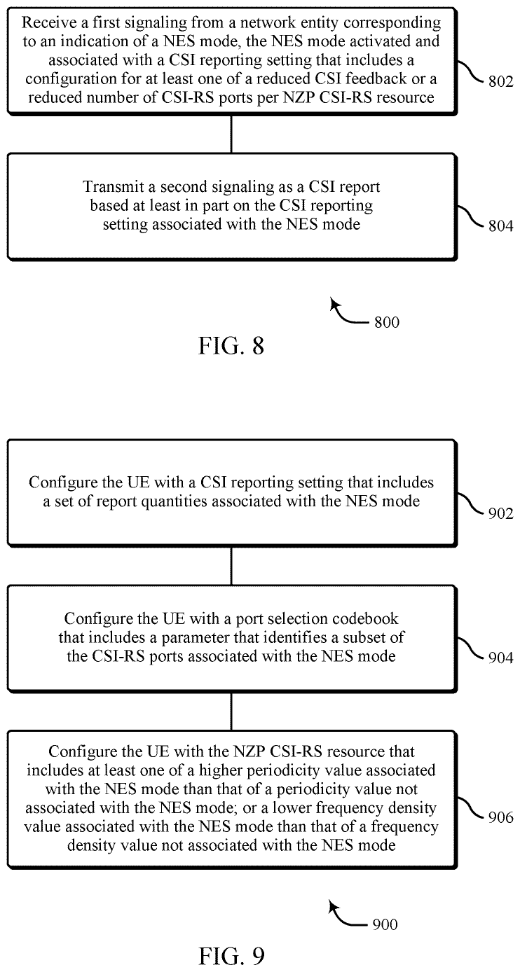

FIG. 8 illustrates a flowchart of a method 800 that supports CSI enhancements for NES in accordance with aspects of the present disclosure. The operations of the method 800 may be implemented by a device or its components as described herein. For example, the operations of the method 800 may be performed by a UE 104 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 802, the method may include receiving a first signaling from a network entity corresponding to an indication of a NES mode, the NES mode activated and associated with a CSI reporting setting that includes a configuration for at least one of a reduced CSI feedback or a reduced number of CSI-RS ports per NZP CSI-RS resource. The operations of 802 may be performed in accordance with examples as described herein. In some implementations, aspects of the operations of 802 may be performed by a device as described with reference to FIG. 1.

At 804, the method may include transmitting a second signaling as a CSI report based at least in part on the CSI reporting setting associated with the NES mode. The operations of 804 may be performed in accordance with examples as described herein. In some implementations, aspects of the operations of 804 may be performed by a device as described with reference to FIG. 1.

FIG. 9 illustrates a flowchart of a method 900 that supports CSI enhancements for NES in accordance with aspects of the present disclosure. The operations of the method 900 may be implemented by a device or its components as described herein. For example, the operations of the method 900 may be performed by a UE 104 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 902, the method may include configuring the UE with a CSI reporting setting that includes a set of report quantities associated with the NES mode. The operations of 902 may be performed in accordance with examples as described herein. In some implementations, aspects of the operations of 902 may be performed by a device as described with reference to FIG. 1.

At 904, the method may include configuring the UE with a port selection codebook that includes a parameter that identifies a subset of the CSI-RS ports associated with the NES mode. The operations of 904 may be performed in accordance with examples as described herein. In some implementations, aspects of the operations of 904 may be performed by a device as described with reference to FIG. 1.

At 906, the method may include configuring the UE with the NZP CSI-RS resource that includes at least one of a higher periodicity value associated with the NES mode than that of a periodicity value not associated with the NES mode; or a lower frequency density value associated with the NES mode than that of a frequency density value not associated with the NES mode. The operations of 906 may be performed in accordance with examples as described herein. In some implementations, aspects of the operations of 906 may be performed by a device as described with reference to FIG. 1.

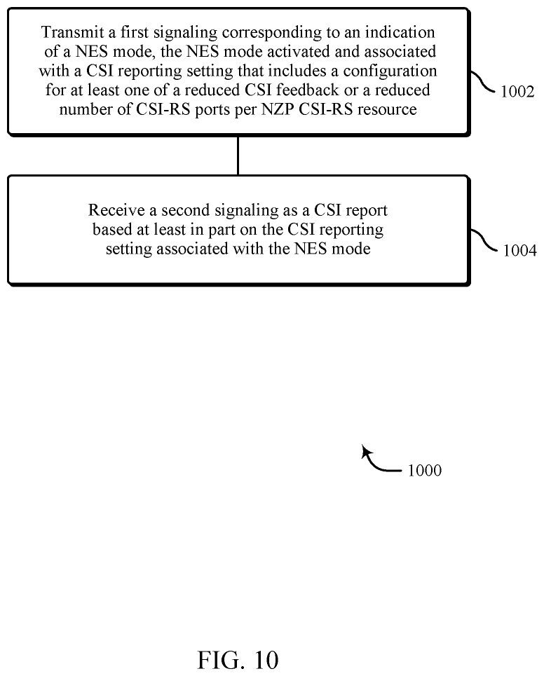

FIG. 10 illustrates a flowchart of a method 1000 that supports CSI enhancements for NES in accordance with aspects of the present disclosure. The operations of the method 1000 may be implemented by a device or its components as described herein. For example, the operations of the method 1000 may be performed by a network entity 102 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1002, the method may include transmitting a first signaling corresponding to an indication of a NES mode, the NES mode activated and associated with a CSI reporting setting that includes a configuration for at least one of a reduced CSI feedback or a reduced number of CSI-RS ports per NZP CSI-RS resource. The operations of 1002 may be performed in accordance with examples as described herein. In some implementations, aspects of the operations of 1002 may be performed by a device as described with reference to FIG. 1.

At 1004, the method may include receiving a second signaling as a CSI report based at least in part on the CSI reporting setting associated with the NES mode. The operations of 1004 may be performed in accordance with examples as described herein. In some implementations, aspects of the operations of 1004 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Similarly, a list of one or more of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and operable to cause the UE to:
receive a first signaling from a network entity corresponding to an indication of a network energy saving (NES) mode, the NES mode activated and associated with a channel state information (CSI) reporting setting that includes a configuration for a reduced number of channel state information reference signal (CSI-RS) ports per non-zero power (NZP) CSI RS resource; and
transmit a second signaling as a CSI report based at least in part on the CSI reporting setting associated with the NES mode.

2. The UE of claim 1, wherein the at least one processor is operable to cause the UE to receive the first signaling from the network entity indicating that the NES mode is activated for the network entity, or for one or more network entities in a wireless communications network that includes the network entity.

3. The UE of claim 1, wherein the NES mode is activated via a parameter of one of the CSI reporting setting, a CSI resource setting, or an NZP CSI-RS resource setting.

4. The UE of claim 1, wherein the NES mode is activated via downlink control information (DCI) corresponding to scheduling a physical uplink shared channel (PUSCH).

5. The UE of claim 4, wherein an identifier of an aperiodic CSI reporting setting is indicated in a CSI reporting trigger list associated with a CSI request field of the DCI.

6. The UE of claim 5, wherein the identifier identifies at least one of a periodic CSI reporting setting or a semi-persistent CSI reporting setting corresponding to an NZP CSI-RS resource setting.

7. The UE of claim 1, wherein the CSI report includes a rank indicator (RI) value that is smaller than or equal to a threshold RI value associated with the NES mode.

8. The UE of claim 1, wherein the at least one processor is operable to cause the UE to be configured with a CSI reporting setting that includes a set of report quantities associated with the NES mode.

9. The UE of claim 8, wherein the set of report quantities includes at least one of:
an indication of a sub-selection of at least one of a set of CSI-RS ports, a set of slots, or a set of frequency sub-bands;
a CSI-RS resource indicator (CRI) corresponding to a CSI-RS resource identifier with a designated number of ports; or
layer-one reference signal received power (L1-RSRP) corresponding to at least one CSI RS resource with the designated number of ports.

10. The UE of claim 1, wherein the at least one processor is operable to cause the UE to be configured with a port selection codebook that includes a parameter that identifies a subset of the CSI-RS ports associated with the NES mode.

11. The UE of claim 1, wherein an NZP CSI-RS resource configuration associated with the NES mode includes at least one parameter corresponding to a grouping of the NZP CSI-RS ports into two or more groups, each associated with an identifier of a respective group.

12. The UE of claim 11, wherein the CSI report includes a CSI-RS resource index (CRI) report quantity value as an index corresponding to a selected group of the NZP CSI-RS ports.

13. The UE of claim 1, wherein the at least one processor is operable to cause the UE to be configured with the NZP CSI-RS resource that includes at least one of:
a higher periodicity value associated with the NES mode than that of a periodicity value not associated with the NES mode; or
a lower frequency density value associated with the NES mode than that of a frequency density value not associated with the NES mode.

14. The UE of claim 1, wherein the CSI report includes a channel quality indicator (CQI) value based at least in part on a precoder matrix indicator (PMI) value reported in a prior CSI report.

15. The UE of claim 1, wherein the NES mode is associated with a single layer corresponding to the CSI, an identification of the single layer is signaled in a form of a layer indicator (LI) value of the CSI report associated with the NES mode.

16. The UE of claim 1, wherein the CSI report includes two channel quality indicator (CQI) values including a first CQI value associated with the NES mode being activated, and a second CQI value associated with the NES mode being deactivated.

17. (canceled)

18. A network entity (NE) for wireless communication, comprising:
at least one memory; and
at least one processor coupled with the at least one memory and operable to cause the NE to:
transmit a first signaling corresponding to an indication of a network energy saving (NES) mode, the NES mode activated and associated with a channel state information (CSI) reporting setting that includes a configuration for a reduced number of channel state information reference signal (CSI-RS) ports per non-zero power (NZP) CSI RS resource; and
receive a second signaling as a CSI report based at least in part on the CSI reporting setting associated with the NES mode.

19. The NE of claim 18, wherein an NZP CSI-RS resource configuration associated with the NES mode includes at least one parameter corresponding to a grouping of the NZP CSI-RS ports into two or more groups, each associated with an identifier of a respective group.

20. A method performed by a user equipment (UE), the method comprising:
receiving a first signaling from a network entity corresponding to an indication of a network energy saving (NES) mode, the NES mode activated and associated with a channel state information (CSI) reporting setting that includes a configuration for a reduced number of channel state information reference signal (CSI-RS) ports per non zero power (NZP) CSI RS resource; and
transmitting a second signaling as a CSI report based at least in part on the CSI reporting setting associated with the NES mode.

21. A method performed by a network entity (NE), the method comprising:
transmitting a first signaling corresponding to an indication of a network energy saving (NES) mode, the NES mode activated and associated with a channel state information (CSI) reporting setting that includes a configuration for a reduced number of channel state information reference signal (CSI-RS) ports per non-zero power (NZP) CSI RS resource; and
receiving a second signaling as a CSI report based at least in part on the CSI reporting setting associated with the NES mode.
